(19) United States
(12) Patent Application Publication
(10) Pub. No.: US 2017/0238546 A1
(43) Pub. Date: Aug. 24, 2017

(54) NOVEL PLANT FUNCTIONAL ACTIVATED NANO VACC-FERTILICEUTICAL, AND METHODS OF PREPARATION, FORMULATION, DILUTION, AND USE THEREOF

(71) Applicant: GREEN INNOVATIVE BIOTECHNOLOGY CO., LTD., Bangbuathong, Nonthaburi (TH)

(72) Inventor: KARSIDETE TEERANITAYATARN, Bangkok (TH)

(73) Assignee: GREEN INNOVATIVE BIOTECHNOLOGY CO., LTD., Bangbuathong, Nonthaburi (TH)

(21) Appl. No.: 15/507,868

(22) PCT Filed: Sep. 3, 2015
(86) PCT No.: PCT/TH15/00054

§ 371 Date: Mar. 1, 2017

(30) Foreign Application Priority Data
Sep. 3, 2014 (TH) 1401005120

(51) Int. Cl. A01N 43/16; C05C 11/00; C05D 3/00; C05D 1/00; C05D 9/00; C05D 9/02; C05G 3/00; C05B 17/00

(52) U.S. Cl. CPC A01N 43/16; C05G 3/00; C05C 11/00; C05B 17/00; C05D 1/00; C05D 9/00; C05D 9/02; C05D 3/00

(57) ABSTRACT

The present invention provides compositions comprising chitooligosaccharides, methods for preparation and use thereof, including for example methods of stimulating the production of significant substances in plants. Functional Activated Nano Vacc-Fertiliceutical for Plant is used to stimulate significant substance production in plant (foliage plant, fruit tree, and flowering plant).

### BACKGROUND OF THE INVENTION

Cultivation of photosynthetic terrestrial and aquatic plants is a major economic activity throughout the world and provides most people with the majority of their caloric requirements. In addition to agricultural production, many types of photosynthetic terrestrial and aquatic plants, such as flowers, are produced for other uses. Cultivation of these photosynthetic species is often complicated by plant diseases and disorders, which can significantly reduce the productivity of farms. Damage during harvest of crops (e.g., wounds on fruit or tubers) is another time at which disease or disease-causing organisms can negatively impact producers. As a result, farmers use a variety of methods to limit plant disorders and diseases, including chemical treatments, which involve added costs and the potential to damage the environmental, local biodiversity, and the health of farmers and other humans consuming or interacting with the agricultural products. These chemical treatments as well as genetic engineering are widely used to improve the ability of a plant to resist disease and as treatment for a disease, but an over-dependence upon these chemical treatments in modern agriculture has led to widespread resistance and led to a desire for more natural ways to promote healthy immune function in plants.

Disease resistance in plants occurs when plants are destroyed, attacked or affected by any causes such as living things (fungi, bacteria, virus) and non-living things (environmental factors—lack of nutrients, drought, lack of oxygen, high temperature, sunlight or pollution) (Freeman and Beattie, 2008). In inappropriate conditions, secondary metabolites are generated, including for example terpenoids, phenolics, alkaloids, proteins, and enzymes.

According to previous studies, it was found that the immune system in plants can be promoted or stimulated using various elicitors. The use of different elicitors also affects different kinds of substance production, for instance, carbohydrate polymers, lipids, glycopeptides, and glycoproteins. These substances are produced to resist destruction of microorganism and encourage many processes of the plants such as active oxygen species (AOS), phytoalexin biosynthesis, strength of cell wall stemmed from phenyl propanoid, callose accumulation, synthesis of other resistant enzymes, and PR protein accumulation (Van Loon and Van Strien, 1999).

Chitosan can stimulate an activity of terpenoids. It is found that chitosan in tomato can induce sesquiterpenes production in tomato leaf (Walker-Simmon et al., 2001). Furthermore, the use of low molecular weight chitosan in potato can induce sesquiterpenes production and phytoalexin production in potato sprout (Vasyukova et al., 2001). Besides, different molecular weight and degree of acetylation affect responsive activity in antimicrobial resistance. The molecular weight has more influence than the degree of acetylation (Sekiguchi et al., 1994). According to an experiment of growth inhibition of Bacillus cereus, Escherichia coli, Staphylococcus aureus, Pseudomonas aeruginosa, Salmonella enteric, Bacillus subtilis, and Klebsiellapneumoniae, the result indicates that the lower molecular weight chitosan provides better growth inhibition of microorganism than the higher one (Jing et al., 2007; Junget al., 2002; Omura et al., 2003). This is because smaller molecule can move faster than the bigger one (Kumar, 2005).

Additionally, oligochitosans can promote hypersensitive response of the plant to the bacteria, virus, and fungi. The destroyed cells will be dead rapidly while protein and phytoalexin are accumulated to prevent diffusion to other normal cells. A concentration of 500 microgram oligochitosans/ml can cause cell death of tobacco at 40.6% within 72 hours (Wang et al., 2008). It can be said that oligochitosans is better elicitor than chitosan polymer as it is found that oligochitosans can better stimulate pisatin phytoalexin production in beans (Kendra and Hadwiger, 1984; Hadwiger et al., 1994). This is concordant with another study on grape leaf which reveals that the use of low molecular weight oligochitosans (1.5 kDa) can activate more phytoalexins production than the high molecular weight oligochitosans (3 and 10 kDa) (Aziz et al., 2006).

Thus, there remains a need in the art for compositions and methods for stimulating production of substances in plants, including substances significant to improving plant immunity and plant growth.

### SUMMARY OF THE INVENTION

Functional Activated Nano Vacc-Fertiliceutical for Plant is used to stimulate significant substance production in plant (foliage plant, fruit tree, and flowering plant). One liter of Functional Activated Nano Vacc-Fertiliceutical for Plant contains:

1. Chitooligosaccharide 0.6% by weight;

2. Organic acid 0.6% by weight;

3. Amino acid 0.5% by weight; and

4. Mineral 1.68% by weight.

The production process of Functional Activated Nano Vacc-Fertiliceutical for Plant used to stimulate the significant substance production in plant (foliage plant, fruit tree, and flowering plant) consists of these following steps:

1. Chitooligosaccharide reaction with organic acid;

2. The product is a Nanobiochitooligosaccharide solution;

3. Nanobiochitooligosaccharide solution reaction with amino acid;

4. The product is a Nanoaminobiochitooligosaccharide substance;

5. Lead Nanoaminobiochitooligosaccharide substance chelating mineral;

6. The product is a Functional Activated Nanovacc Fertiliceutical For Plant; and

7. Packaging products.

Instructions of Functional Activated Nano Vacc-Fertiliceutical for Plant used to stimulate the significant substance production in plant (foliage plant, fruit tree, and flowering plant) are as follows:

Instructions of Functional Activated Nano Vacc-Fertiliceutical for Plant used to stimulate the significant substance production in the foliage plant:

1. Prepare 20 ml of Functional Activated Nano Vacc-Fertiliceutical for Plant and mix with 1 liter of water. Then mix together and soak seeds/stems to plant in 1 rai in the solution for 6 hours.

2. Bring the soaked seeds/stems to plant in prepared plots.

3. After 14 days of growing young plants, prepare 40 ml of Functional

Activated Nano Vacc-Fertiliceutical for Plant to mix with 20 liters of water. Then mix all ingredients together to spray on the plots using a sprayer. The quantity of this mixture is 20 liters per 1 rai. Spray the solution every 7-15 days until harvest. If the young plants are moved, start spraying again after 14 days of moving.

Instructions of Functional Activated Nano Vacc-Fertiliceutical for Plant used to stimulate the significant substance production in the fruit tree:

1. Prepare 40 ml of Functional Activated Nano Vacc-Fertiliceutical for Plant and mix with 20 liters of water (to spray for 1 rai). Then mix all together and spray on the plants every 15-30 days until inflorescence. Mix 80 ml of Functional Activated Nano Vacc-Fertiliceutical for Plant with 20 liters of water (to spray for 1 rai). After 15 days of spraying, prepare 40 ml of Functional Activated Nano Vacc-Fertiliceutical for Plant and mix with 20 liters of water (to spray for 1 rai). Then spray on the plants every 15-30 days until the inflorescence.

Instructions of Functional Activated Nano Vacc-Fertiliceutical for Plant used to stimulate the significant substance production in the flowering plant:

1. Prepare 40 ml of Functional Activated Nano Vacc-Fertiliceutical for Plant and mix with 20 liters of water (to spray for 1 rai). Then mix together and soak seeds/stems to plant in 1 rai in the solution for 6 hours.

2. Bring the soaked seeds/stems to plant in the provided plots.

3. After 14 days of growing young plants (young plant period), prepare 40 ml of Functional Activated Nano Vacc-Fertiliceutical for. Plant to mix with 20 liters of water. Then mix all ingredients together to spray on the plots using the sprayer. The quantity of this mixture is 20 liters per 1 rai. Spray the solution every 7-15 days until flower bud initiation. After that, prepare 80 ml of Functional Activated Nano Vacc-Fertiliceutical for Plant to mix with 20 liters of water. Mix them together and spray on the plot using the sprayer every 15-30 days until flowering stage for harvesting. Consequently, mix 40 ml of Functional Activated Nano Vacc-Fertiliceutical for Plant and 20 liters of water to spray on the plots every 15-30 days until the flower bud initiation.

Inspection Methods of Significant Substance Production in Plant (Foliage Plant, Fruit Tree, and Flowering Plant):

1. Activation of significant substance production in plant (foliage plant, fruit tree, and flowering plant)

Randomly collect the plants from 1-rai plot of each group. Then distill or extract the samples to find out the quantity of significant substances such as flavonoid, phenolic, alkaloids, etc. (depending on botanical characteristics of each plant). Afterwards, compare the data between the use and the non-use of Functional Activated Nano Vacc-Fertiliceutical for Plant.

In one embodiment, the invention is a composition comprising a chitooligosaccharide, an organic acid, an amino acid, and a mineral. In one embodiment, the organic acid is lactic acid. In one embodiment, the amino acid is methionine. In one embodiment, the mineral comprises nitrogen, phosphorus, potassium, sulfur, manganese, zinc, calcium, silicon, ferrous, and iron. In one embodiment, the chitooligosaccharide has a variable molecular weight and a variable degree of deacetylation. In one embodiment, the molecular weight of the chitooligosaccharide ranges from about 2.0×10² to about 2.0×10³, and the degree of deacetylation ranges from about 84% to about 96%. In another embodiment, the molecular weight of the chitooligosaccharide ranges from about 4.0×10⁴ to about 4.0×10⁵, and the degree of deacetylation ranges from about 81% to about 92%. In another embodiment, the molecular weight of the chitooligosaccharide ranges from about 3.0×10⁶ to about 3.0×10⁷, and the degree of deacetylation ranges from about 75% to about 85%.

In one embodiment, the invention is a composition comprising a chitooligosaccharide, an organic acid, an amino acid, a mineral, and a diluent. In one embodiment, the diluent is water. In one embodiment, the concentration of chitooligosaccharide is about 0.6%, the concentration of organic acid is about 0.6%, the concentration of amino acid is about 0.5%, and the concentration of mineral is about 1.68%. In another embodiment, the concentrations are by weight.

In one embodiment, the invention is a method of preparing the composition of claim 1, comprising: providing a chitooligosaccharide; adding an organic acid; adding an amino acid; and adding a mineral. In one embodiment, the organic acid is lactic acid. In another embodiment, the amino acid is methionine. In another embodiment, the mineral comprises nitrogen, phosphorus, potassium, sulfur, manganese, zinc, calcium, silicon, ferrous, and iron.

In one embodiment, the invention is a method of preparing a diluted composition of chitooligosaccharide, comprising mixing a chitooligosaccharide, an organic acid, an amino acid, and a mineral with water.

In one embodiment, the invention is a method of stimulating the production of a substance in a plant, comprising administering a composition comprising a chitooligosaccharide, an organic acid, an amino acid, and a mineral, to any one of: the plant, the seeds of the plant, and the stem of the plant. In one embodiment, the plant is a foliage plant. In another embodiment, the plant is a fruit tree. In another embodiment, the plant is a flowering plant. In another embodiment, the plant is basil. In another embodiment, the plant is chili. In another embodiment, the plant is rice. In one embodiment, the substance is a flavonoid. In another embodiment, the substance is a phenolic substance. In another embodiment, the substance is an alkaloid. In another embodiment, the substance is a terpenoid. In another embodiment, the substance is a protein. In another embodiment, the substance is an enzyme. In another embodiment, the substance is a carotenoid. In another embodiment, the substance is a capsaicinoid. In another embodiment, the substance is a fatty acid. In one embodiment, the composition is administered before or after a culture of the plant has been established, and the administration comprises spraying an amount of the composition over an area of terrain, in a ratio expressed as cubic centimeters (cc) of composition/1 rai. In one embodiment, the composition is sprayed every three days. In another embodiment, the composition is sprayed every six days. In another embodiment, the composition is sprayed every twelve days. In one embodiment, the ratio is 40 cc/1 rai. In another embodiment, the ratio is 80 cc/1 rai. In another embodiment, the ratio is 120 cc/1 rai. In another embodiment, the ratio is 160 cc/1 rai.

In one embodiment, the invention is a kit for stimulating the production of a substance in a plant, comprising an amount of a composition comprising a chitooligosaccharide, an organic acid, an amino acid, and a mineral, and an instruction manual for the use thereof.

### DETAILED DESCRIPTION OF THE INVENTION

The present invention relates to compositions comprising chitooligosaccharides and methods of preparation and use thereof. The compositions of the invention are used to stimulate production of certain substances in plants. An increased production of these substances is desirable in various plants for a variety of reasons. In one aspect, increased production of a substance relates to improving immunity in plants. In another embodiment, increased production of a substance relates to improving growth of the plants. In another embodiment, increased production of a substance is a desirable because the substance itself is the reason for growing the plants. This invention aims to utilize Functional Activated Nano Vacc-Fertiliceutical for Plant to stimulate substance production in plants, for example foliage plants, fruit trees, and flowering plants, by preparing the seeds or the stems of the plants, and spraying the solution on plots cultivated with the plants, in order to activate higher production of substances than usual. These significant substances produced by the plant are beneficial to 1) the growth—prevent danger from sunlight, both direct and indirect, promote growth, increase pigments of yield, inhibit growth of fungi, bacteria, and virus, generate toxic for insects and pests, etc., 2) the quality of yield—amount of significant substances, antioxidants, pigment concentration of yield, and storage life. The use of Functional Activated Nano Vacc-Fertiliceutical for Plant to promote and stimulate the significant substance production is important for the plant and entrepreneurs. In aspects of the plant, it is helpful for disease resistance, quality of yield such as color, prolongation of storage, disease prevention after harvest, and damage reduction of yield. In addition, the use of Functional Activated Nano Vacc-Fertiliceutical for Plant can encourage specific characteristics of the plant. For instance, basil tang is stemmed from β-30 Caryophyllene, β-elemene, metyleugenol, and methyl chavicol. Several types of substances produced by the basil such as vitamin C, phenolic, and flavonoid play an important role as antioxidants. Besides, methanol extracted from the basil can be utilized as the antioxidants as well including superoxide anion, hydroxyl radical, superoxide radical, and iron capture (Hakkim et al., 2007).

### Definitions

As used herein, each of the following terms has the meaning associated with it in this section. Unless defined otherwise, all technical and scientific terms used herein generally have the same meaning as commonly understood by one of ordinary skill in the art to which this invention belongs. Generally, the nomenclature used herein, and the laboratory and field procedures in agriculture, chemistry, and formulation science, are those well-known and commonly employed in the art.

The articles “a” and “an” are used herein to refer to one or to more than one, i.e., to at least one of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

The term “or,” as used herein, means “and/or” unless explicitly indicated to refer to alternatives only or the alternatives are mutually exclusive, although the disclosure supports a definition that refers to only alternatives and “and/or.”

As used herein, the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

As used herein, the term “vacc-fertiliceutical” refers to a composition which increases the production of a substance in a plant, and as a result confers to the plant increased immunity, and/or increased growth characteristics, and provides protection of plants from natural stress conditions, including, without being limiting, wounding and pathogenic infections, such as viruses, bacteria, fungi or insects but also heat, cold or drought. Immunity can refer generally to the plants' resistance to environmental factors, either living (for example various pests, microbes, etc.), or non-living (for example high or low temperature, high or low humidity, etc.). Increased growth characteristics can refer generally to any physical attributes of the plants, for example increased production of the stimulated substance itself, increased production of other substances, or increased production of various parts of the plants (leafs, fruits, roots, stems, seeds, etc.).

As used herein, the term “oligosaccharide” refers to a saccharide compound, the molecule of which is formed by a sequence of a small number of or, in particular, 2 to 10 monosaccharide units connected in series.

As used herein, the term “molecular weight,” or alternatively “molecular mass,” refers to the mass of a molecule, calculated as the mass of each constituent atom multiplied by the number of atoms of that kind in the molecule. When used in the context of polymeric materials, such as saccharides or oligosaccharides, where the material comprises molecules of variable lengths, “molecular weight” may refer both a range of molecular weights, or to an average molecular weight.

As used herein, the term “deacetylation” refers to the removal of an acetyl group from an acetamido moiety in a molecule, with an amino group remaining in place.

As used herein, the term “DD” or “degree of deacetylation,” refers to the process of eliminating or reducing acetyl group (CH₃CO) which indicates chitin and chitosan. If the value is low, there is high quantity of chitin. On the other hand, if the value is high, there is high quantity of chitosan.

As used herein, the term “organic acid” refers to an organic compound with acidic properties, examples of which include, but are not limited to carboxylic acids and sulfonic acids.

As used herein, the term “amino acid” refers to an organic compound comprising both at least a carboxylic group and at least an amino group.

As used herein, the term “nanoaminobiochitooligosaccharide” refers to compounds comprising amino acid, chitosan and saccharide. Bring through biological processes, to provide a smaller molecules to the nanoscale.

As used herein, the term “mineral” refers to mineral extracts from shell shime, shell crab, fish and humus. To change the structure by biotechnological method until changes are compounds that have a unique delivery mechanism in plant, similar to the delivery of drugs in the bodies people.

As used herein, the term “rai” refers to a unit of area equivalent to 1600 square meters, or 0.3954 acres.

As used herein, the term “kD” means kilodalton, and refers to the unified atomic mass unit or Dalton (symbol: Da), which is the standard unit that is used for indicating mass on an atomic or molecular scale (atomic mass). One unified atomic mass unit is approximately the mass of one single proton or neutron and is equivalent to 1 g/mol.

The terms “increase,” “increasing,” “stimulate,” or “stimulating,” and variations of these terms, as used herein include any measurable increase.

A “disease” is a state of health of a plant wherein the plant cannot maintain homeostasis, and wherein if the disease is not ameliorated then the plant's health continues to deteriorate. In contrast, a “disorder” in a plant is a state of health in which the plant is able to maintain homeostasis, but in which the plant's state of health is less favorable than it would be in the absence of the disorder. Left untreated, a disorder does not necessarily cause a further decrease in the plant's state of health. Disease and disorder are used interchangeably herein.

As used herein, “treating a disease or disorder” means reducing the frequency with which a symptom of the disease or disorder is experienced by a plant. A disease or disorder is “alleviated” if the severity of a symptom of the disease or disorder, the frequency with which such a symptom is experienced by a patient, or both, is reduced.

An “effective amount” or “therapeutically effective amount” of a compound is that amount of compound which is sufficient to provide a beneficial effect to the subject, such as a plant, to which the compound is administered. An “effective amount” of a delivery vehicle is that amount sufficient to effectively bind or deliver a compound.

The phrase “aqueous solvent,” as used herein, refers to any and all solvent systems comprising at least water, capable of dissolving, suspending, or otherwise dispersing chitooligosaccharides.

The term “topical,” as used herein, refers to the administration of the compositions of the invention to any exposed area of a plant, or to the seeds of the plant. Application of a composition of the invention to the roots, stem, leafs, or fruits of a plant are all examples of topical administration.

The phrase “effective amount,” as used herein, refers to an amount that is sufficient or effective to prevent or treat (delay or prevent the onset of, prevent the progression of, inhibit, decrease or reverse) a disease or condition associated with a plant, including stimulating the production of a substance in a plant, and stimulating immunity in a plant.

As used herein, “additional ingredients” include, but are not limited to, one or more of the following: excipients; surface active agents; dispersing agents; inert diluents; granulating and disintegrating agents; binding agents; lubricating agents; sweetening agents; flavoring agents; coloring agents; preservatives; physiologically degradable compositions such as gelatin; aqueous vehicles and solvents; oily vehicles and solvents;

suspending agents; dispersing or wetting agents; emulsifying agents; demulcents; buffers; salts; thickening agents; fillers; emulsifying agents; antioxidants; antibiotics; antifungal agents; stabilizing agents; and agriculturally acceptable polymeric or hydrophobic materials.

As used herein, an “instructional material” includes a publication, a recording, a diagram, or any other medium of expression which can be used to communicate the usefulness of the composition of the invention for its designated use. The instructional material of the kit of the invention may, for example, be affixed to a container which contains the composition or be shipped together with a container which contains the composition. Alternatively, the instructional material may be shipped separately from the container with the intention that the instructional material and the composition be used cooperatively by the recipient.

Throughout this disclosure, various aspects of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

### Description

In one aspect, the invention relates to a Functional Activated Nano Vacc-Fertiliceutical for Plants. The present invention relates partly to the unexpected discovery that the Functional Activated Nano Vacc-Fertiliceutical can increase the production of a significant substance in a plant, for example including, but not limited to, a substance related to plant immunity.

In one embodiment, the Functional Activated Nano Vacc-Fertiliceutical for Plant comprises two types of substances: 1) a stimulant, or elicitor, and 2) a precursor. These two parts are nanoparticles which are useful for fast absorption of the plant. Its activation is similar to a vaccine to strengthen immunity of the plant. The precursor is added to immediately complete the process of the plant without the wait of photosynthesis. Moreover, it helps encourage the process to occur as intended.

Functional Activated Nano Vacc-Fertiliceutical for Plant of the invention can promote the significant substance production through the process that stimulates the plant to produce the immunity and several substances.

### Compositions of the Invention

In one aspect, the invention relates to a composition comprising chitooligosaccharides. In one embodiment, the chitooligosaccharides are derived from chitosan. Chitosan is a polysaccharide produced by deacetylation of chitin, which is a natural polysaccharide, containing acetylated amino groups. Chitosan comprises acetylated and deacetylated amino groups. The ratio can be measured by nuclear magnetic resonance (NMR) spectroscopy, and is expressed as % degree of deacetylation (% DD). The DD in commercially available chitosan ranges from about 60% to about 100%. Chitosan is processed in mixtures of macromolecules of variable length and mass, called chitooligosaccharides. In one embodiment of the invention, the molecular weight of the chitooligosaccharides ranges from about 2.0×10² to about 2.0×10³, and the degree of deacetylation ranges from about 84% to about 96%. In another embodiment, the molecular weight of the chitooligosaccharides ranges from about 4.0×10⁴ to about 4.0×10⁵, and the degree of deacetylation ranges from about 81% to about 92%. In another embodiment, the molecular weight of the chitooligosaccharides ranges from about 3.0×10⁶ to about 3.0×10⁷, and the degree of deacetylation ranges from about 75% to about 85%.

Chitins and chitosans, are major components of the cell walls of fungi and the exoskeletons of insects and crustaceans. Chitinous compounds include chitin, (IUPAC: N-[5-[[3-acetylamino-4, 5-dihydroxy-6-(hydroxymethyl)oxan-2yl]methoxymethy-1]-2-[[5-acetylamino-4,6-dihydroxy-2-(hydroxy methyl)oxan-3-yl]methoxymethyl]-4-hydroxy-6-(hydroxymethyl)oxan-3-ys]etha-namide), and chitosan, (IUPAC: 5-amino-6-[5-amino-6-[5-amino-4,6-dihydroxy-2(hydroxymethypoxan-3-yl]oxy-4-hydroxy-2-(hydroxymethyl) oxan-3-yl]oxy-2(hydroxymethyl)oxane-3,4-diol). These compounds may be obtained commercially, e.g., from Sigma-Aldrich, or prepared from insects, crustacean shells, or fungal cell walls. Methods for the preparation of chitin and chitosan are known in the art, and have been described, for example, in U.S. Pat. No. 4,536,207 (preparation from crustacean shells), Pochanavanich, et al., Lett. Appl. Microbiol. 35:17-(2002) (preparation from fungal cell walls), and U.S. Pat. No. 5,965,545 (preparation from crab shells and hydrolysis of commercial chitosan). Deacetylated chitins and chitosans may be obtained that range from less than about 35% to greater than about 90% deacetylation, and cover a broad spectrum of molecular weights, e.g., low molecular weight chitosan oligomers of less than 15 kD and chitin oligomers of 0.5 to 2 kD; “practical grade” chitosan with a molecular weight of about 150 kD; and high molecular weight chitosan of up to about 700 kD.

In another aspect, the invention relates to a composition comprising chitooligosaccharides and an organic acid. Organic acids are organic compounds with acidic properties, such as for example carboxylic acids or sulfonic acids. Embodiments of the invention contain for example acids such as formic acid, acetic acid, propionic acid, butyric or butanoic acid, valeric or pentanoic acid, caproic or hexanoic acid, oxalic acid, lactic acid, gluconic acid, glutaric acid, glutamic acid, fumaric acid, citric acid, malic acid, maleic acid, benzoic acid, and mixtures thereof. In some embodiments, organic acids have 6 carbon atoms or less, while in other embodiments, organic acids have 4 carbon atoms or less. In one embodiment, the organic acid is lactic acid.

In another aspect, the invention relates to a composition comprising an amino acid. Amino acids are organic compounds comprising both a carboxylic and an amino group. Embodiments of the invention contain for example amino acids such as histidine, alanine, isoleucine, arginine, leucine, asparagine, lysine, aspartic acid, methionine, cysteine, phenylalanine, glutamic acid, threonine, glutamine, tryptophan, glycine, valine, pyrrolysine, proline, selenocysteine, serine, and tyrosine. In one embodiment, the amino acid is methionine.

In another aspect, the invention relates to a composition comprising a mineral. In one embodiment, the mineral is a mineral extract. In another embodiment, the mineral extract is obtained from shell shime, shell crab, fish and humus. In another embodiment, the mineral is selected from the group consisting of nitrogen, phosphorus, potassium, sulfur, manganese, zinc, calcium, silicon and ferrous, or iron. In another embodiment, the mineral comprises nitrogen, phosphorus, potassium, sulfur, manganese, zinc, calcium, silicon and ferrous, or iron.

In one aspect, the invention relates to a Functional Activated Nano Vacc-Fertiliceutical for plants, which is a concentrated composition comprising chitooligosaccharides, an organic acid, and amino acid and a mineral. In one embodiment, the composition is formulated into nanoparticles. In another embodiment, the composition is diluted with a diluent to afford a ready for use formulation of the Functional Activated Nano Vacc-Fertiliceutical for plants. In one embodiment, the diluent is an aqueous diluent comprising water and at least one other solvent miscible with water, examples of which include, but are not limited to, an alcohol and a glycol. In one embodiment, the diluent is water. In one embodiment, the concentration of chitooligosaccharides in the ready to use formulation is about 0.6% by weight. In another embodiment, the concentration of organic acid in the ready to use formulation is about 0.6% by weight. In another embodiment, the concentration of amino acid in the ready to use formulation is about 0.5% by weight. In another embodiment, the concentration of mineral in the ready to use formulation is about 1.68% by weight.

In another aspect, the Functional Activated Nano Vacc-Fertiliceutical for plants composition may also comprise additional active agents with fungicidal, bactericidal or virucidal activity or other compounds suitable to activate the plants' own defense system. Such compounds are well known in the art and examples for the first type of compound include, without being limiting, insecticides, fungicides, bactericides, nematicides, herbicides, molluscicides while examples for the second type of compound include, without being limiting, chloronicotinyl or benzothiadiazole-derivates (US 2009/0018019 or U.S. Pat. No. 4,931,581) or mixtures of several of these active agents. Further examples of commonly employed active agents suitable for combination with the plant protective composition of the present invention include, without being limiting, tebuconazol, fludioxonil, metconazol, thiophanat-methyl, fluoxastrobin, prothioconazol, prochloraz, fluquinconazol, spiroxamine, difenoconazol, epoxiconazol, prothioconazol, triticonazol, dimoxystrobin, dimethoat, lambda-cyhalothrin, thiamethoxam, pirimiphos-methyl, metaflumizone, thiacloprid, beta-cyfluthrin, imidacloprid, spinosad, chlorantraniliprole, clothianidin, deltamethrin, diflubenzuron, spirodiclofen, alpha-cypermethrin, zeta-cypermethrin, boscalid, dimoxystrobin, metconazol, mepiquat or triadimenol.

In one embodiment, the composition of the invention is a solution. In another embodiment, the composition of the invention is an emulsion. In another embodiment, the composition of the invention can be formulated into liposomes and microdroplets.

As would be understood by one skilled in the art, an emulsion consists of a mixture of two or more immiscible liquids, i.e., contains multiple phases. Emulsions are distinct from solutions, which contain one or essentially only one phase. One of the liquids in an emulsion is the dispersed phase, and is dispersed in the other phase, which is the continuous phase. In one type of emulsion, a continuous liquid phase surrounds droplets of water, i.e., water-in-oil emulsion. In another type of emulsion, oil is dispersed within a continuous water phase, i.e., oil-in-water emulsion. As it would be understood by one skilled in the art, the phrases “water-in-oil” and “oil-in-water” are used for exemplification purposes only, as an emulsion can be generally formed by any two immiscible liquids, including two nonaqueous immiscible liquids. Emulsification is the process by which emulsions are prepared. In one embodiment, a composition of the present invention is a component of an emulsion, such as a water-in-oil or an oil-in-water emulsion, including, but not limited to a lipid emulsion, such as a soybean oil emulsion. For example, a composition comprising chitooligosaccharides dissolved in a solution comprising an aqueous solvent may also comprise a lipid emulsion or an oil-in-water emulsion.

In certain embodiments, the emulsion of the invention may have a lipid component. In various embodiments, the lipid component may comprise an amount ranging from about 1% to 99%, from about 5% to about 75%, from about 10% to about 60%, from about 20% to about 50%, or from about 30% to about 40%, v/v of the emulsion. In various embodiments, the lipid component of the emulsion may be soybean oil, long chain triglyceride, castor oil, corn oil, cottonseed oil, olive oil, peanut oil, peppermint oil, safflower oil, sesame oil, soybean oil, hydrogenated soybean oil, hydrogenated vegetable oil, medium chain triglycerides coconut oil, palm see oil and derivatives, medium chain (C8/C10) mono-and diglycerides, d-alpha-tocopherol, soy fatty acids, or combinations thereof.

In certain embodiments, the emulsion of the invention comprises chitooligosaccharides and an aqueous solvent, and may further comprise an emulsifier. An emulsifier is a substance that stabilizes an emulsion. An emulsifier may also be known as an emulgent. An emulsifier may also be a surfactant. In various embodiments, the emulsifier may be egg phospholipid, purified egg phospholipids, Polyoxyl 35 castor oil (Cremophor EL), Polyoxyl 40 hydrogenated castor oil (Cremophor RH 40), Polyoxyl 60 hydrogenated castor oil (Cremophor RH 60), Polysorbate 20, Polysorbate 80, d-alpha-tocopheryl polyethylene glycol 1000 succinate, Solutol HS-15, propylene glycol, or combinations thereof. Various concentrations of an emulsifier may be used with the present invention. For example, a composition of the present invention comprising chitooligosaccharides may comprise about 0.1%-99%, 0.1%-60%, 5%-50%, 10%-40%, 5%-25%, 10%-30%, 10%-25%, 25%-50%, 10%-75%, 25%-75%, 10%-65%, 25%-65%, 10%-60%, 25%-60%, 0.1%, 1%, 5%, 10%, 20%, 25%, 30%, 35%, 40%, 45%, 50%, 55%, 60%, 65%, 70%, 75%, 80% or any range derivable therein, of an emulsifier.

In other embodiments, the emulsion of the invention has a perfluorocarbon component. In various embodiments, the perfluorocarbon component may comprise an amount ranging from about 0.1% to 99%, from about 5% to about 75%, from about 10% to about 60%, from about 20% to about 50%, or from about 30% to about 40%, v/v of the emulsion. In various embodiments, perfluorocarbon may provide additional advantages due to its limited toxicity. In one embodiment, the emulsion of the invention comprises chitooligosaccharides, a perfluorocarbon, and an emulsifier.

In various embodiments, the compositions of the present invention may be components of liposome suspensions. A liposome, for example, multilamellar, unilamellar, and/or multivesicular liposomes, is a microscopic, spherical, fluid-filled structure, with walls comprising one or more layers of phospholipids and molecules similar in physical and/or chemical properties to those that make up mammalian cell membranes. By way of nonlimiting examples, liposomes may be formed from a variety of natural membrane components, such as cholesterol, stearylamine, or phosphatidylcholine, such as for example described in U.S. Pat. Nos. 5,120,561 and 6,007,838, each of which is incorporated herein by reference in its entirety, or of pure surfactant components like DOPE (dioleoylphosphatidyl-ethanolamine). Liposomes may be formulated to incorporate a wide range of materials as a payload either in the aqueous, or in the lipid compartments, or in both. Generally, lipophilic active substances dissolve in the bilayer, amphiphilic substances become associated with the phospholipid membrane and hydrophilic substances occur in solution in the enclosed aqueous volume, such as for example described by Artmann et al., 1990, Drug Res. 40 (II) 12:1363-1365, incorporated herein by reference in its entirety.

Liposome compositions of the invention may comprise any range of liposome and chitooligosaccharides components, according to the methods and detailed description set forth herein. By way of a non-limiting example, a liposome component of a composition of the invention may include from about 0.1% to about 99.9% liposome component, or more preferably, from about 0.1% to about 50% liposome component, and even more preferably, from about 0.1% to about 30% liposome component. In various embodiments, the liposome of the invention comprises cholesterol, stearylamine, phosphatidylcholine, dioleoylphosphatidylethanolamine, or combinations thereof.

In various embodiments, the composition of the present invention may also be a component of a micro-droplet. A micro-droplet of the invention consists of a sphere of organic liquid phase that ranges in diameter from about 200 Angstroms to about 10,000 Angstroms that is covered by a monolayer of a suitable lipid. Preferred lipids are phospholipids, which are natural constituents of biological membranes and as such are biologically compatible. Compounds useful for preparing microdroplets include phosphatidylcholine (lecithin), sphingomyelin, phosphatidic acid, phosphatidyl serine, phosphatidyl inositol, diphosphatidyl glycerol and phosphatidyl glycerol. Micro-droplets may be prepared by sonication, including probe or bath sonication, homogenization, microfluidization or by high intensity mechanical agitation. The preferred method of preparing the microdroplets of the invention is by sonication with a probe sonicator. Alternatively, micro-droplets may be prepared in a bath sonicator.

In various embodiments, the compositions of the present invention may also be a component of a liquid suspension. Liquid suspensions may be prepared using conventional methods to achieve suspension of the active ingredient in an aqueous or oily vehicle. Aqueous vehicles include, for example, water and isotonic saline. Oily vehicles include, for example, almond oil, oily esters, ethyl alcohol, vegetable oils such as arachis, olive, sesame, or coconut oil, fractionated vegetable oils, and mineral oils such as liquid paraffin. Liquid suspensions may further comprise one or more additional ingredients including, but not limited to, suspending agents, dispersing or wetting agents, emulsifying agents, demulcents, preservatives, buffers, salts, flavorings, coloring agents, and sweetening agents. Oily suspensions may further comprise a thickening agent. Known suspending agents include, but are not limited to, sorbitol syrup, hydrogenated edible fats, sodium alginate, polyvinylpyrrolidone, gum tragacanth, gum acacia, and cellulose derivatives such as sodium carboxymethylcellulose, methylcellulose, and hydroxypropyl methylcellulose. Known dispersing or wetting agents include, but are not limited to, naturally occurring phosphatides such as lecithin, condensation products of an alkylene oxide with a fatty acid, with a long chain aliphatic alcohol, with a partial ester derived from a fatty acid and a hexitol, or with a partial ester derived from a fatty acid and a hexitol anhydride (e.g., polyoxyethylene stearate, heptadecaethyleneoxycetanol, polyoxyethylene sorbitol monooleate, and polyoxyethylene sorbitan monooleate, respectively). Known emulsifying agents include, but are not limited to, lecithin and acacia. Known preservatives include, but are not limited to, methyl, ethyl, or n-propyl para-hydroxybenzoates, ascorbic acid, and sorbic acid. Known sweetening agents include, for example, glycerol, propylene glycol, sorbitol, sucrose, and saccharin. Known thickening agents for oily suspensions include, for example, beeswax, hard paraffin, and cetyl alcohol.

### Methods of the Invention

In one aspect, the invention relates to a method of preparing a Functional Activated Nano Vacc-Fertiliceutical for Plants. In one embodiment, the method comprises the step of providing a chitooligosaccharide. In another embodiment, the method comprises the step of adding an organic acid. In another embodiment, the chitooligosaccharide reacts with the organic acid. In one embodiment, the product of the addition of the organic acid to the chitooligosaccharide is a nanobiochitooligosaccharide solution. In one embodiment, the method comprises the step of adding an amino acid to the nanobiochitooligosaccharide solution. In another embodiment, the nanobiochitooligosaccharide solution reacts with the amino acid. In one embodiment, the product of adding the amino acid to the nanobiochitooligosaccharide solution is a nanoaminobiochitooligosaccharide substance. In one embodiment, the method comprises the step of adding a mineral to the nanoaminobiochitooligosaccharide substance. In another embodiment, the mineral is a chelating mineral.

In one aspect, the invention relates to a method of diluting the Functional Activated Nano Vacc-Fertiliceutical for Plants with a diluent, in order to prepare a ready to use formulation. In one embodiment, the diluent is water. In one embodiment, the ratio of Functional Activated Nano Vacc-Fertiliceutical to water is determined in regard to the scope of the particular end use. For example, dilution can be determined in regard to the final volume of ready to use formulation desired. In one embodiment, 20 cubic centimeters (cc) of Functional Activated Nano Vacc-Fertiliceutical can be added to 1 liter of water. In other embodiments, 40 cc, 80 cc, 120 cc, or 160 cc can be added to 1 liter of water. In another embodiment, dilution can be determined in regard to the surface area of land which needs to be sprayed with the ready to use formulation, and the amount of Functional Activated Nano Vacc-Fertiliceutical desired to be applied to the same area. In one embodiment, 40 cc of Functional Activated Nano Vacc-Fertiliceutical is diluted with enough water to spray 1 rai of land (1 rai=1600 square meters). In another embodiment, 80 cc of Functional Activated Nano Vacc-Fertiliceutical is diluted with enough water to spray 1 rai of land. In another embodiment, 120 cc of Functional Activated Nano Vacc-Fertiliceutical is diluted with enough water to spray 1 rai of land. In another embodiment, 160 cc of Functional Activated Nano Vacc-Fertiliceutical is diluted with enough water to spray 1 rai of land. In one embodiment, the water necessary to prepare the ready to use formulation for spraying 1 rai of land is 20 liters.

In one aspect, the invention relates to a method of stimulating the production of a substance in a plant. In one embodiment, examples of the plant include, but are not limited to, a foliage plant, a fruit tree, and a flowering plant. In one embodiment, the plant is chili. In another embodiment, the plant is basil. The basil stemmed from Functional Activated Nano Vacc-Fertiliceutical for Plant is different from original basil due to its tang, darker color, and higher quantity of essential oil. In another embodiment, the plant is rice. In another embodiment, the plant is selected from the group consisting of monocotyledonous plants and dicotyledonous plants. The term “monocotyledonous plants” refers to a group of plants that is characterized by having one seed-leaf (cotyledon), while the term “dicotyledonous plants” refers a second group of plants characterized by having two embryonic leaves. Non-limiting examples of monocotyledonous plants include wheat, oats, millet, barley, rye, maize, rice, sorghum, triticale, spelt and sugar cane while non-limiting examples of dicotyledonous plants include Arabidopsis, fibre plants (cotton, flax, hemp, jute), buckwheat, vines, tea, hops, pistachio, cress, linseed, oil plants (rape, mustard, poppy, olives, sunflowers, coconut, castor oil plants, cocoa beans, groundnuts), vegetables (e.g. spinach, lettuce, asparagus, cabbages, carrots, onions, tomatoes, potatoes, paprika, brassicas), aubergines, corn, tobacco, tagetes, calendula, cucumber plants (such as cucumber, marrows, melons), soft fruit (e.g. apples, pears, plums, peaches, almonds, cherries, strawberries, raspberries and blackberries), citrus fruit (such as oranges, lemons, grapefruit, mandarins), pumpkin/squash, courgette, beet (e.g. sugar beet and fodder beet), drupes (e.g. coffee, jujube, mango, palms such as e.g. date palms), lauraceae (e.g. avocados, cinnamon, camphor), ornamentals (e.g. flowers, shrubs, deciduous trees and conifers) and legumes (such as beans, lentils, peas, soybeans). In accordance with the present invention, the plants can be traditional crop plants or plant varieties having new properties, which have been obtained by breeding with conventional methods, mutagenesis or by recombinant DNA techniques. Thus, the plants may include transgenic plants and plant hybrids.

In one embodiment, the substance whose production is stimulated is a significant substance, examples of which include, but are not limited to a flavonoid, a phenolic substance, an alkaloid, a terpenoid, a protein, and an enzyme. In one embodiment, the substance is related to plant immunity. In another embodiment, increasing the production of the substance increases the immunity of the plant. In another embodiment, the substance is substance desirable for agricultural purposes, such as for example, but not limited to, the substance, the plant itself, or both, are suitable and desirable for human consumption or use. In one embodiment, the substance is a sesquiterpenes. In another embodiment, the substance is a carotenoid. In another embodiment, the substance is a capsaicinoid. In one embodiment, the substance is selected from the group consisting of β-30 Caryophyllene, β-elemene, metyleugenol, methyl chavicol, and capsaicin. In one embodiment, the substance is a fatty acid. In another embodiment, the substance is a volatile fatty acid.

In one embodiment, the method comprises applying a composition of the invention to the seeds of the plant, or the plant itself, such as for example, but not limited, to the roots, stem, leafs, fruits, etc., of the plant. In one embodiment, the method of stimulating the production of a substance in a plant is practiced before a culture of the plant has been established. In another embodiment, the method of stimulating the production of a substance in a plant is practiced after a culture of the plant has been established. In one embodiment, the compositions of the invention are sprayed over a surface of terrain comprising the culture of as plant. In one embodiment, the composition is sprayed every three days. In another embodiment, the composition is sprayed every six days. In another embodiment, the composition is sprayed every twelve days. In one embodiment, the composition is sprayed in a ratio of 40 cc/1 rai. In another embodiment, the composition is sprayed in a ratio of 80 cc/1 rai. In another embodiment, the composition is sprayed in a ratio of 120 cc/1 rai. In another embodiment, the composition is sprayed in a ratio of 160 cc/1 rai.

In one embodiment, the plants can be contacted with the compositions of the invention by any method known in the art. In another embodiment, the plants are contacted by any one method selected from the group consisting of spraying, scattering, pouring, coating and dusting. In one embodiment, a spray may be provided comprising the composition of the invention in liquid form dispersed in a gas or vapors, such that small droplets of the composition are formed. The spray then enables to distribute the compositions over a surface area, such as for example a single plant or a field comprising a plurality of plants. The dispersion of the composition in a gas or vapors is also referred to as atomizing. The composition in a liquid state may also be scattered onto plants or a field or may be poured onto the plants or a field. Furthermore, parts of the plant or entire plants can be coated with the compositions of the present invention, for example by dipping the plant into the composition or by brushing the plants, or parts thereof, with the composition. Alternatively, or additionally, the composition may be applied by dusting, i.e. the (aerial) application of the composition in powder form. Furthermore, the composition may also be introduced into the soil on which the plants are growing, for example in form of a liquid, granules, pellets or a stick, which can disintegrate with time in order to release the composition of the invention. The above described means of application lead to either a foliar application, application to the stem or buds, application to (and uptake through) the roots in case of application to the soil or application to the seeds. One skilled in the art would appreciate that the particular method of application has to be selected depending on the respective circumstances and the target of the treatment.

In one embodiment, the amount administered is an amount effective to stimulate production of a substance in a plant, including but not limited to, effective to increase plant immunity. In one embodiment, the method of treatment includes delivering to the plant a diluted aqueous chitooligosaccharide composition. In one embodiment, when administered topically to the plant, the diluted chitooligosaccharide composition has a chitooligosaccharide concentration ranging from about 0.1% to about 1.0% by weight. In another embodiment, the diluted chitooligosaccharide composition has a chitooligosaccharide concentration of about 0.1% by weight. In another embodiment, the diluted chitooligosaccharide composition has a chitooligosaccharide concentration of about 0.2% by weight. In another embodiment, the diluted chitooligosaccharide composition has a chitooligosaccharide concentration of about 0.3% by weight. In another embodiment, the diluted chitooligosaccharide composition has a chitooligosaccharide concentration of about 0.4% by weight. In another embodiment, the diluted chitooligosaccharide composition has a chitooligosaccharide concentration of about 0.5% by weight. In another embodiment, the diluted chitooligosaccharide composition has a chitooligosaccharide concentration of about 0.6% by weight. In another embodiment, the diluted chitooligosaccharide composition has a chitooligosaccharide concentration of about 0.7% by weight. In another embodiment, the diluted chitooligosaccharide composition has a chitooligosaccharide concentration of about 0.8% by weight. In another embodiment, the diluted chitooligosaccharide composition has a chitooligosaccharide concentration of about 0.9% by weight. In another embodiment, the diluted chitooligosaccharide composition has a chitooligosaccharide concentration of about 1.0% by weight.

The amount of the compositions of the invention to be administered depends on the particular plant, and/or the particular substance. For example, the dose will depend on the type of plant. The dose may be different, for instance, if the plant is a foliage plant, a fruit tree, or a flowering plant. The dose may also depend on the area of the plant where the composition is administered. The dose may be different, for instance, if the composition is administered to the seeds of the plant, and the dose may be also different if the composition is administered to the roots, the stem, the leafs, or the fruits of the plant. The dose may also depend on the concentration of the chitooligosaccharide in the composition, or the MW and DD of the chitooligosaccharide. The dose may be different, for instance, if the molecular weight of the chitooligosaccharides ranges from 2.0×10² to 2.0×10³, and the degree of deacetylation ranges from 84% to 96%, or the molecular weight of the chitooligosaccharides ranges from 4.0×10⁴ to 4.0×10⁵, and the degree of deacetylation ranges from 81% to 92%, or the molecular weight of the chitooligosaccharides ranges from 3.0×10⁶ to 3.0×10⁷, and the degree of deacetylation ranges from 75% to 85%.

The methods of the present invention can comprise administering a formulation of the invention alone, or in combination with other agents that modulate or enhance plant immunity, stimulate production of substance in a plant, or otherwise beneficially impact the agricultural production of the plant. For example, in one embodiment, agents comprising a formulation of the invention can be administered in combination with one or more fertilizers. In another embodiment, agents comprising a formulation of the invention can be administered in combination with one or more pesticides, herbicides, fungicides, insecticides, insect growth regulators, nematicides, termiticides, molluscicides, piscicides, avicides, rodenticides, predacides, bactericides, insect repellents, animal repellents, antimicrobials, disinfectants or antimicrobials, and sanitizers. As used herein, two agents are said to be administered in combination when the two agents are administered simultaneously or are administered independently in a fashion such that the agents will act at the same time.

### Kits of the Invention

The invention also relates to a kit for stimulating the production of a substance in a plant. In one embodiment, the kit includes an amount of a composition of the invention and an instruction manual. The compositions of the invention may be provided to the professional in charge of administering the composition to the plants, along with an instructional material. In one embodiment, the instructional material is part of a kit. The instructional material includes a publication, a recording, a diagram, or any other medium of expression, which may be used to communicate the usefulness of the composition and/or compounds used in the practice of the invention in a kit. The instructional material of the kit may, for example, be affixed to a container that contains the compound and/or composition used in the practice of the invention or shipped together with a container that contains the compound and/or composition. Alternatively, the instructional material may be shipped separately from the container with the intention that the recipient uses the instructional material and the compound cooperatively. Delivery of the instructional material may be, for example, by physical delivery of the publication or other medium of expression communicating the usefulness of the kit, or may alternatively be achieved by electronic transmission, for example by means of a computer, such as by electronic mail, or download from a website.

It is contemplated that any embodiment discussed in this specification may be implemented with respect to any method or composition of the invention, and vice versa. Furthermore, compositions of the invention may be used to achieve methods of the invention.

Other objects, features and advantages of the present invention will become apparent from the detailed description herein. It should be understood, however, that the detailed description and the specific examples, while indicating specific embodiments of the invention, are given by way of illustration only, since various changes and modifications within the spirit and scope of the invention will become apparent to those skilled in the art from this detailed description.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

### Materials and Methods

After preparing soil for plantation, the area is divided into 13 groups and each one consists of 1 rai. Then, provide the seeds or the stems to soak in 20 ml of Functional Activated Nano Vacc-Fertiliceutical for Plant mixed with 1 liter for 6 hours. Consequently, plant the seeds or the stems in the plots of 13 groups and spray Functional Activated Nano Vacc-Fertiliceutical for Plant after 14 days of growing young plants. Additional details are provided as follows.

The 1st group: Controlled group (no spraying).

The 2nd group: Spray Functional Activated Nano Vacc-Fertiliceutical for Plant every 3 days by using a ratio of 40 cc per 1 rai.

The 3rd group: Spray Functional Activated Nano Vacc-Fertiliceutical for Plant every 3 days by using a ratio of 80 cc per 1 rai.

The 4th group: Spray Functional Activated Nano Vacc-Fertiliceutical for Plant every 3 days by using a ratio of 120 cc per 1 rai.

The 5th group: Spray Functional Activated Nano Vacc-Fertiliceutical for Plant every 3 days by using a ratio of 160 cc per 1 rai.

The 6th group: Spray Functional Activated Nano Vacc-Fertiliceutical for Plant every 6 days by using a ratio of 40 cc per 1 rai.

The 7th group: Spray Functional Activated Nano Vacc-Fertiliceutical for Plant every 6 days by using a ratio of 80 cc per 1 rai.

The 8th group: Spray Functional Activated Nano Vacc-Fertiliceutical for Plant every 6 days by using a ratio of 120 cc per 1 rai.

The 9th group: Spray Functional Activated Nano Vacc-Fertiliceutical for Plant every 6 days by using a ratio of 160 cc per 1 rai.

The 10th group: Spray Functional Activated Nano Vacc-Fertiliceutical for Plant every 12 days by using a ratio of 40 cc per 1 rai.

The 11th group: Spray Functional Activated Nano Vacc-Fertiliceutical for Plant every 12 days by using a ratio of 80 cc per 1 rai.

The 12th group: Spray Functional Activated Nano Vacc-Fertiliceutical for Plant every 12 days by using a ratio of 120 cc per 1 rai.

The 13th group: Spray Functional Activated Nano Vacc-Fertiliceutical for Plant every 12 days by using a ratio of 160 cc per 1 rai.

Then the data are collected and the plants are harvested as follows.

### Inspection Methods of Significant Substance Production in Plant (Foliage Plant, Fruit Tree, and Flowering Plant)

Randomly collect the plants from 1-rai plot of each group. Then distill or extract the samples to find out the quantity of significant substances such as flavonoid, phenolic, alkaloids, etc. (depending on botanical characteristics of each plant). Afterwards, compare the data between the use and the non-use of Functional Activated Nano Vacc-Fertiliceutical for Plant.

Analysis of variance: ANOVA is conducted regarding randomized completely design (RCD) to compare differences of average of each group using Duncan's new multiple range test (DMRT) at a 99% level of reliability and SPSS.

### Instructions of Functional Activated Nano Vacc-Fertiliceutical for Plant used to Stimulate the Significant Substance Production in the Foliage Plant

1. Prepare 20 ml of Functional Activated Nano Vacc-Fertiliceutical for Plant and mix with 1 liter of water. Then mix together and soak seeds/stems to plant in 1 rai in the solution for 6 hours.

2. Bring the soaked seeds/stems to plant in prepared plots.

3. After 14 days of growing young plants, prepare 40 ml of Functional Activated Nano Vacc-Fertiliceutical for Plant to mix with 20 liters of water. Then mix all ingredients together to spray on the plots using a sprayer. The quantity of this mixture is 20 liters per 1 rai. Spray the solution every 7-15 days until harvest. If the young plants are moved, start spraying again after 14 days of moving.

### Instructions of Functional Activated Nano Vacc-Fertiliceutical for Plant used to Stimulate the Significant Substance Production in the Fruit Tree

1. Prepare 40 ml of Functional Activated Nano Vacc-Fertiliceutical for Plant and mix with 20 liters of water (to spray for 1 rai). Then mix all together and spray on the plants every 15-30 days until inflorescence. Mix 80 ml of Functional Activated Nano Vacc-Fertiliceutical for Plant with 20 liters of water (to spray for 1 rai). After 15 days of spraying, prepare 40 ml of Functional Activated Nano Vacc-Fertiliceutical for Plant and mix with 20 liters of water (to spray for 1 rai). Then spray on the plants every 15-30 days until the inflorescence.

### Instructions of Functional Activated Nano Vacc-Fertiliceutical for Plant used to Stimulate the Significant Substance Production in the Flowering Plant

1. Prepare 40 ml of Functional Activated Nano Vacc-Fertiliceutical for Plant and mix with 20 liters of water (to spray for 1 rai). Then mix together and soak seeds/stems to plant in 1 rai in the solution for 6 hours.

2. Bring the soaked seeds/stems to plant in the provided plots.

3. After 14 days of growing young plants (young plant period), prepare 40 ml of Functional Activated Nano Vacc-Fertiliceutical for Plant to mix with 20 liters of water. Then mix all ingredients together to spray on the plots using the sprayer. The quantity of this mixture is 20 liters per 1 rai. Spray the solution every 7-15 days until flower bud initiation. After that, prepare 80 ml of Functional Activated Nano Vacc-Fertiliceutical for Plant to mix with 20 liters of water. Mix them together and spray on the plot using the sprayer every 15-30 days until flowering stage for harvesting. Consequently, mix 40 ml of Functional Activated Nano Vacc-Fertiliceutical for Plant and 20 liters of water to spray on the plots every 15-30 days until the flower bud initiation.

### Example 1

### Functional Activated Nano Vacc-Fertiliceutical for Plant as used to Stimulate Significant Substance Production in Plant (Foliage Plant, Fruit Tree, and Flowering Plant)

One liter of Functional Activated Nano Vacc-Fertiliceutical for Plant contains:

1. Chitooligosaccharide 0.6% by weight;

2. Organic acid 0.6% by weight;

3. Amino acid 0.5% by weight; and

4. Mineral 1.68% by weight.

### Example 2

### The Production Process of Functional Activated Nano Vacc-Fertiliceutical for Plant used to Stimulate the Significant Substance Production in Plant (Foliage Plant, Fruit Tree, and Flowering Plant)

The production process consists of these following steps:

1. Chitooligosaccharide reaction with organic acid;

2. The product is a Nanobiochitooligosaccharide solution;

3. Nanobiochitooligosaccharide solution reaction with amino acid;

4. The product is a Nanoaminobiochitooligosaccharide substance;

5. Lead Nanoaminobiochitooligosaccharide substance chelating mineral;

6. The product is a Functional Activated Nano Vacc-Fertiliceutical for Plant;

7. Packaging products.

### Example 3

### Results of the Use of Functional Activated Nano Vacc-Fertiliceutical for Plant to Stimulate the Essential Oil Production of Basil

According to the use of all ratios of Functional Activated Nano Vacc-Fertiliceutical for Plant, the results show that the amount of essential oil extracted from the basil is higher than the controlled group. Moreover, the difference with statistical significance is also found. Particularly, the use of Functional Activated Nano Vacc-Fertiliceutical for Plant at 40 cc per 1 rai every 12 days provides the highest quantity of essential oil per weight of basil-sesquiterpenes.

### Example 4

### Results of the Use of Functional Activated Nano Vacc-Fertiliceutical for Plant to Stimulate the Production of Cap Saicin and Carotenoids of Chili

Regarding the use of all ratios of Functional Activated Nano Vacc-Fertiliceutical for Plant in chili plantation system from soaking the seeds until harvesting, the results demonstrate that the use of Functional Activated Nano Vacc-Fertiliceutical for Plant with the mixture of 40 cc of solution and 20 liters of water every 15 days and the harvest when the chili entirely turns red can stimulate higher production of carotenoids, compared to the control group, with statistical significance.

The extraction of capsaicinoids in the chili illustrates that the use of Functional Activated Nano Vacc-Fertiliceutical for Plant affects higher volume of capsaicinoids in the chili with the statistical significance. However, it is different from another controlled group because the stimulation of immune system of the plant can encourage and induce the production of phenolics and alkaloids (Freeman and Beattie, 2008).

### Example 5

### Results of the Use of Functional Activated Nano Vacc-Fertiliceutical for Plant to Stimulate the Leaf Hair Production of Rice

This study investigates the length of leaf hair of rice which can represent higher quantity of cutin production. A comparison between the controlled group without any use of Functional Activated Nano Vacc-Fertiliceutical for Plant and the group using Functional Activated Nano Vacc-Fertiliceutical for Plant is conducted. The mixture of 40 cc of solution and 20 liters of water per 1 rai is applied to spray on the plots every 15 days. Then the data are gathered by randomly selecting 20 pieces of 60-day leaves of the rice after sowing. Consequently, the leaf hair is inspected to measure its length. The findings indicate that the group using Functional Activated Nano Vacc-Fertiliceutical for Plant has the longest leaf hair (15 micrometers) which is different from the controlled group with the statistical significance (6 micrometers).

The disclosures of each and every patent, patent application, and publication cited herein are hereby incorporated herein by reference in their entirety.

All of the compositions and methods disclosed and claimed herein may be made and executed without undue experimentation in light of the present disclosure.

While the compositions and methods of this invention have been described in terms of preferred embodiments, it will be apparent to those of skill in the art that variations may be applied to the compositions and methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A composition comprising a chitooligosaccharide, an organic acid, an amino acid, and a mineral.

2. The composition of claim 1, wherein the organic acid is lactic acid.

3. The composition of claim 1, wherein the amino acid is methionine.

4. The composition of claim 1, wherein the mineral comprises nitrogen, phosphorus, potassium, sulfur, manganese, zinc, calcium, silicon, ferrous, and iron.

5. The composition of claim 1, wherein the chitooligosaccharide has a variable molecular weight and a variable degree of deacetylation.

6. The composition of claim 5, wherein the molecular weight of the chitooligosaccharide ranges from about 2.0×10² to about 2.0×10³, and the degree of deacetylation ranges from about 84% to about 96%.

7. The composition of claim 5, wherein the molecular weight of the chitooligosaccharide ranges from about 4.0×10⁴ to about 4.0×10⁵, and the degree of deacetylation ranges from about 81% to about 92%.

8. The composition of claim 5, wherein the molecular weight of the chitooligosaccharide ranges from about 3.0×10⁶ to about 3.0×10⁷, and the degree of deacetylation ranges from about 75% to about 85%.

9. The composition of claim 1, further comprising a diluent.

10. The composition of claim 9, wherein the diluent is water.

11. The composition of claim 9, wherein the concentration of chitooligosaccharide is about 0.6%, the concentration of organic acid is about 0.6%, the concentration of amino acid is about 0.5%, and the concentration of mineral is about 1.68%.

12. The composition of claim 11, wherein the concentrations are by weight.

13. A method of preparing the composition of claim 1, comprising:
providing a chitooligosaccharide;
adding an organic acid;
adding an amino acid; and
adding a mineral.

14. The method of claim 13, wherein the organic acid is lactic acid.

15. The method of claim 13, wherein the amino acid is methionine.

16. The method of claim 13, wherein the mineral comprises nitrogen, phosphorus, potassium, sulfur, manganese, zinc, calcium, silicon, ferrous, and iron.

17. A method of preparing a diluted composition of chitooligosaccharide, comprising mixing the composition of claim 1 with water.

18. A method of stimulating the production of a substance in a plant, comprising administering the composition of claim 1 to any one of: the plant, seeds of the plant, and a stem of the plant.

19. The method of claim 18, wherein the plant is a foliage plant.

20. The method of claim 18, wherein the plant is a fruit tree.

21. The method of claim 18, wherein the plant is a flowering plant.

22. The method of claim 18, wherein the plant is basil.

23. The method of claim 18, wherein the plant is chili.

24. The method of claim 18, wherein the plant is rice.

25. The method of claim 18, wherein the substance is a flavonoid.

26. The method of claim 18, wherein the substance is a phenolic substance.

27. The method of claim 18, wherein the substance is an alkaloid.

28. The method of claim 18, wherein the substance is a terpenoid.

29. The method of claim 18, wherein the substance is a protein.

30. The method of claim 18, wherein the substance is an enzyme.

31. The method of claim 18, wherein the substance is a carotenoid.

32. The method of claim 18, wherein the substance is a capsaicinoid.

33. The method of claim 18, wherein the substance is a fatty acid.

34. The method of claim 18, wherein the composition is administered before or after a culture of the plant has been established, and the administration comprises spraying an amount of the composition over an area of terrain, in a ratio expressed as cubic centimeters (cc) of composition/1 rai.

35. The method of claim 34, wherein the composition is sprayed every three days.

36. The method of claim 34, wherein the composition is sprayed every six days.

37. The method of claim 34, wherein the composition is sprayed every twelve days.

38. The method of claim 34, wherein the ratio is 40 cc/1 rai.

39. The method of claim 34, wherein the ratio is 80 cc/1 rai.

40. The method of claim 34, wherein the ratio is 120 cc/1 rai.

41. The method of claim 34, wherein the ratio is 160 cc/1 rai.

42. A kit for stimulating the production of a substance in a plant, comprising an amount of a composition of claim 1, and an instruction manual for the use thereof.
